(19) United States
(12) Patent Application Publication
(10) Pub. No.: US 2005/0206502 A1
(43) Pub. Date: Sep. 22, 2005

(54) Method and apparatus for releasing a vehicle for a user

(76) Inventor: Georg Bernitz, Nuernberg (DE)

Correspondence Address: BEYER WEAVER & THOMAS LLP, P.O. BOX 70250, OAKLAND, CA, 94612-0250, US

(21) Appl. No.: 11/108,332

(22) Filed: Apr. 18, 2005

Related U.S. Application Data
(63) Continuation of application No. PCT/EP04/08532, filed on Jul. 29, 2004.

(30) Foreign Application Priority Data
Aug. 27, 2003 (DE) 103 39476.1

(51) Int. Cl. H04B 1/00

(52) U.S. Cl. 340/5.82

(57) ABSTRACT

In a method and an apparatus for releasing a vehicle for a user, first, a unique body-related feature of the user is detected at the vehicle. The detected feature and an identification associated to the vehicle are transmitted by the vehicle to a management unit disposed remote from the vehicle, where the detected signal is compared to a feature stored for the vehicle. If the detected feature and the stored feature match, the vehicle is released for usage.

### CROSS-REFERENCE TO RELATED APPLICATION

This application is a continuation of copending International Application No. PCT/EP04/008532, filed Jul. 29, 2004, which designated the United States and was not published in English.

### BACKGROUND OF THE INVENTION

1. Field of the Invention

The present invention relates to method and an apparatus for releasing a vehicle for a user.

2. Description of the Related Art

Normally, vehicles are released for a user due to the fact that the user has a suitable key, with which he can unlock the vehicle and start it. When the vehicle is not owned by the user, but, for example, a rented vehicle, it is first required that the user of the vehicle signs a contract with the lender, wherein the user (hirer) proves his driving ability in the form of the driver's license to the lender within the conclusion of this contract and after the conclusion of the contract, he obtains the vehicle key required for releasing the vehicle from the lender. Even where the possibility of reserving or renting via the Internet exists, a user always has to go to the lender or one of his service points in order to obtain the respective vehicle key, independent on how he proves his driving ability to the lender.

Similar problems occur with all usage types of vehicles, which do not belong to the user, which means, apart from rental cars, also with common car sharing models, where it is required that the user does not only correspond with the usual users but also has to go a certain location where the vehicle key is kept.

The above-described procedures are disadvantageous, since they all require that the user goes to the lender or the agency providing the vehicle in order to obtain the vehicle key, which is essential for using the vehicle from there or any other location. Before this key is handed out, the user also has to identify himself and, if necessary, prove his driving ability.

### SUMMARY OF THE INVENTION

It is an object of the present invention to provide a method and an apparatus for releasing a vehicle for a user, which enables releasing in a simple manner without the user having to go to certain locations prior to using the vehicle in order to obtain the key of the vehicle required for usage.

In accordance wit a first aspect, the present invention provides a method for releasing a vehicle for a user, having the steps of: (a) detecting at least one unique body-related feature of the user at the vehicle; (b) transmitting the detected feature and an identification associated to the vehicle from the vehicle to a management unit disposed remote from the vehicle; (c) comparing the detected feature with a feature for the vehicle stored in the management unit; and (d) releasing the vehicle for the user if the detected feature and the stored feature match.

In accordance with a second aspect, the present invention provides an apparatus for releasing a vehicle for a user, having: a sensor associated to the vehicle for detecting at least one body-related unique feature of the user; a communication means associated to the vehicle for sending the detected feature and an identification associated to the vehicle and for receiving a release signal if the detected feature corresponds to a feature associated to the vehicle; and a releasing means, which releases the vehicle for usage in response to the received release signal.

Preferably, the unique body-related feature is a fingerprint, a print of the iris and/or a DNA of the user. Detecting the body-related feature can be performed via a sensor at a vehicle door and/or via a sensor inside the vehicle for starting the vehicle. The detected data are preferably transmitted via a wireless connection, e.g. the mobile network or similar connections, to the management unit. Preferably, position information relating to the vehicle and/or further vehicle specific information, such as tank filling, service status etc. are transmitted to the management unit. Preferably, the identification information of the user and at least the unique body-related feature of the user are stored in the management unit and associated to the selected vehicle.

Preferably, after registration of the user, the user information is stored in the management unit, particularly the body-related feature and the driver's license, which are associated to the corresponding vehicle in the management unit for the case that the user wants to use a vehicle.

The present invention is based on the knowledge that the expensive procedure as it has been required in the prior art for using a vehicle, which is not owned by the user, can be avoided in a simple and elegant way in that the user registers in a central management unit and deposits the required data for his identification, such as a fingerprint etc., together with his driver's license. For the case that he wants to use a vehicle, the registered user can inform the management unit, for example by telephone or internet, whereby a corresponding association of his information to a certain vehicle is made. As soon as this is made, the user receives the required information about the vehicle, its location, etc. Here, it should be noted that the registration of the user is not compulsory. Alternatively, merely the association of the corresponding data mentioned above can be performed when renting the vehicle without requiring a previous registration. In that case, the required data can also be transmitted in an electronic way.

As soon as the user has received the respective vehicle information, he goes to the vehicle and actuates, according to a preferred embodiment, first a fingerprint sensor disposed at the door. The vehicle detects the fingerprint signal detected by the sensor and transmits the same to the management unit, together with a message identifying the vehicle, preferably via a secure, which means coded communication path. In the management unit, a comparison between the received data and the stored data is performed. If this comparison is negative, no enable signal is transmitted to the vehicle, and the vehicle is not released. If, however, the detected features and the stored features match, the transmission unit sends a corresponding release message to the vehicle, and after receiving the same the vehicle effects the release of the vehicle door so that the user can get into the vehicle.

According to a preferred embodiment of the present invention, the vehicle can additionally comprise a corresponding fingerprint sensor, which enables starting the vehicle, which is advantageous, since even in the case of a break-in, a movement of the vehicle can be safely avoided. Testing the fingerprint data detected by the start sensor is performed in the same way as described above and when the vehicle obtains the enable signal, it effects the starting of the motor.

This procedure has a plurality of advantages, wherein it should be mentioned that it is no longer required that the user goes to the lender to collect the key. A further advantage is that the lender or similar agencies can provide vehicles at different locations, for example within a city area, and a vehicle, which is in his proximity, can be allocated to the user. Thus, it is no longer necessary that the user goes to a remote parking area, which is often at airports or large arterial roads of the cities in order to collect the vehicle.

### BRIEF DESCRIPTION OF THE DRAWINGS

These and other objects and features of the present invention will become clear from the following description taken in conjunction with the accompanying drawings, in which:

FIG. 1 is a flow diagram illustrating the inventive method in more detail; and

FIG. 2 is a schematic representation of the inventive apparatus.

### DESCRIPTION OF THE PREFERRED EMBODIMENTS

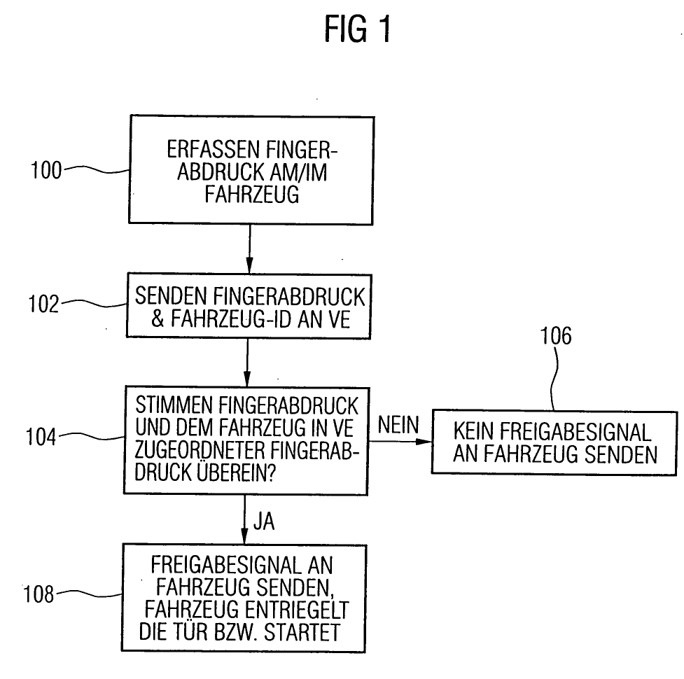

The inventive method is explained in more detail in FIG. 1 with reference to a flow diagram. In a first step 100, a fingerprint from a user, which is already registered, is detected at or in the vehicle (at the door or the starter). In step 102, this fingerprint is sent to a management unit (VE) together with a vehicle identification, which examines in step 104 whether the fingerprint matches a fingerprint associated to a vehicle as stored in the management unit. If this is not the case, no release signal is transmitted to the vehicle as indicated in step 106. Otherwise, the release signal is transmitted to the vehicle in step 108. In response to receiving the enable signal, the vehicle unlocks the door and starts its motor, respectively.

Although a preferred embodiment of the present invention has been described above with regard to a fingerprint sensor, the present invention is not limited to that. Indeed, any unique body-related identification feature for a user can be used, such as, apart from the fingerprint, the iris or the DNA. It should be noted that other biometric data can be used instead or together with the mentioned features as well.

The user can be registered in the management unit, and for the case that he wants to use a vehicle, his identification information is associated to a certain vehicle together with his feature. Alternatively, it can be provided that the user leaves the required data in the management unit and is at the same time associated to a vehicle, so that the advance registration is not compulsory. Preferably, apart from the body-related feature, other identification information for the user is stored in the center unit, such as his name, address, driver's license, etc. Further, it can be provided that the management unit receives further information related to the user from other locations, such as police, registration offices, etc. in order to obtain further information with regard the driver's license of the user, so that for the case that the driver's license of the user has been confiscated this can be noted, and that, when the vehicle is used again, its release is refused.

Additionally, further information with regard to the rental contract can be stored, such as information with regard to the usage radius, the usage period or the like of the vehicle. This information can be transmitted to the vehicle together with the release signal, which, for example, always determines the location via the GPS system, so that here, in dependence on received usage information, a usage outside the usage radius, such as outside the city or a certain country, is prevented and/or after the expiry of the usage length further usage of the vehicle is prevented and a note is given to the user that he either has left the allowable usage radius and/or that the usage period has expired.

Further, the vehicle can transmit vehicle specific information, such as tank filling, mileage, information with regard to inspection etc. to the management unit, to enable servicing from the distance and at the same time perform automatic billing after the usage period has expired, for example based on the tank filling and the mileage.

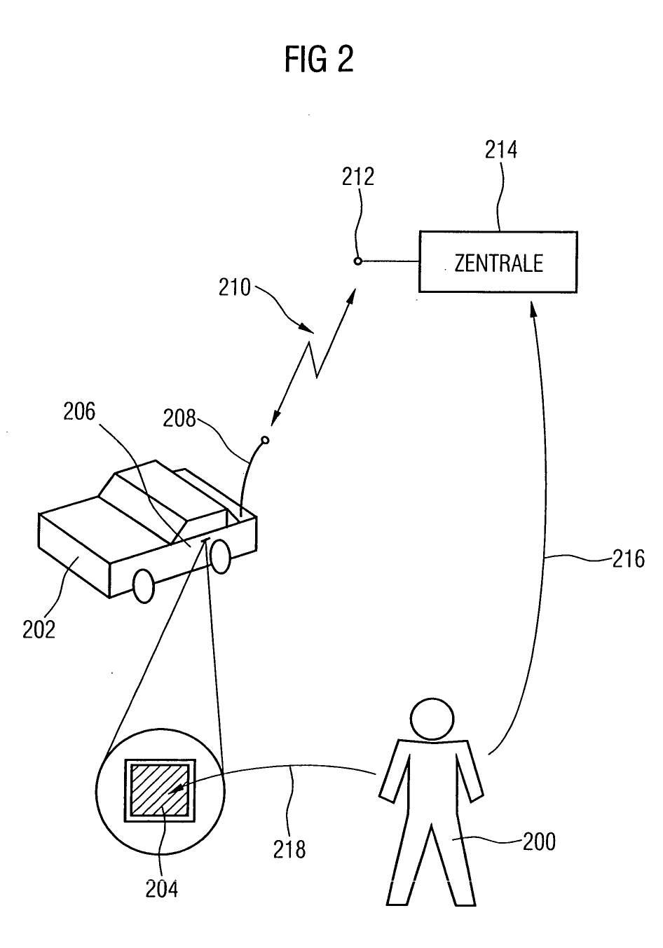

In FIG. 2, the vehicle 202 to be used by the user 200 is shown. The vehicle 202 comprises a fingerprint sensor 204, which is disposed in the area of the door 206 of the vehicle 202. Additionally, according to a preferred embodiment, a further sensor can be provided at the dashboard of a vehicle 202 to detect the same feature or different feature from the user, wherein the motor of the vehicle 202 is then started based on a positive comparison. The vehicle 202 comprises an antenna 208 as part of a wireless communication means, which can effect a transmission of data, as is already schematically indicated at 210, between the vehicle 202 and an antenna 212 of the central management unit 214. In the central management unit 214, the association of user and its unique body-related feature and the vehicle 202 is made, wherein the user 200 requests the vehicle 202 via the central unit 214 and also registers there and leaves the required data, respectively, as it is schematically illustrated by the arrow 216. As soon as the required association of user and vehicle has been performed in the central unit 214, the user 200 can effect a release of the vehicle 202 by leaving a fingerprint at the sensor 204, as it is schematically illustrated by the arrow 218.

Although above preferred embodiments of the present invention have been described with regard to the usage of vehicles, the present invention is not limited to that. Rather, the present invention can be applied to all vehicles, aircrafts, watercrafts, and land vehicles, which can be used by a user within the framework of a rental contract. This encloses, for example, also sailing yachts, which are rented for certain time periods, but also agricultural machinery which is rented for certain harvest usages.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A method for enabling a keyless usage of a vehicle by a user, comprising the steps of:
(a) detecting at least one unique body-related feature of the user at the vehicle;
(b) transmitting the detected feature and an identification associated to the vehicle from the vehicle to a management unit disposed remote from the vehicle;
(c) comparing the detected feature with a feature for the vehicle stored in the management unit; and
(d) releasing the vehicle for the usage if the detected feature and the stored feature match.

2. The method according to claim 1, wherein the step (a) comprises detecting a fingerprint, an iris and/or a DNA of the user.

3. The method according to claim 1, wherein the step (a) comprises detecting via a sensor at a vehicle door and/or detecting via a sensor inside the vehicle for starting the vehicle.

4. The method according to claim 1, wherein the step (b) comprises transmitting via a wireless connection.

5. The method according to claim 1, wherein in step (b) further position information with regard to the vehicle and/or further vehicle-specific information is transmitted to the management unit.

6. The method according to claim 1, wherein identification information of the user and at least one unique body-related feature of the user are stored in the management unit and associated to the vehicle.

7. The method according to claim 1, further comprising the following step prior to step (a):
associating the user-related information to the vehicle in the management unit.

8. The method according to claim 7, wherein the user-related information is stored in the management unit prior to the step of associating.

9. An apparatus for enabling a keyless usage of a vehicle by a user, comprising:
a sensor associated to the vehicle for detecting at least one body-related unique feature of the user;
a communicator associated to the vehicle for sending the detected feature and an identification associated to the vehicle and for receiving a release signal if the detected signal corresponds to a feature associated to the vehicle; and
a releaser, which releases the vehicle for usage in response to the received release signal.

10. The apparatus according to claim 9, wherein the sensor comprises a fingerprint sensor, an iris sensor and/or a DNA sensor.

11. The apparatus according to claim 9, wherein the sensor comprises a door sensor and/or a starter sensor.

12. The apparatus according to claim 9, having a management unit disposed remote from the vehicle, which is adapted to communicate with the vehicle via its communicator to receive the detected feature and the vehicle identification and to transmit the release signal, when a comparison of the received feature with a feature for the vehicle stored in the management unit indicates a match.
